(19) United States
(12) Patent Application Publication
(10) Pub. No.: US 2002/0133360 A1
(43) Pub. Date: Sep. 19, 2002

(54) Method for raising funds with burial structures

(76) Inventors: J. Murray Hill II, Boulder, CO (US); R. Madison Spencer, Charlottesville, VA (US)

Correspondence Address: BRINKS HOFER GILSON & LIONE, P.O. BOX 10395, CHICAGO, IL, 60610, US

(21) Appl. No.: 09/755,777

(22) Filed: Jan. 5, 2001

(51) Int. Cl. G06F 17/60

(52) U.S. Cl. 705/1

(57) ABSTRACT

A method of raising funds and storing and displaying in a secure fashion a variable plurality of cremation storage vessels has the steps of a provider providing a storage and display case to an entity. The storage and display case retains in a secure fashion a plurality of cremation storage vessels. The storage and display case has a plurality of hollow cavities, each having an opening on a front face of the cavity; defined interior storage and display positions for said cremation storage vessels and other personal memorabilia; a storage vessel retainer disposed adjacent to the display positions for locking vessels disposed in those display positions; a decorative face block attachable with said front face of the cavities. The method continues by reserving and selling said cavities by the entity to donors and having an agreement between said provider and the entity that a specified portion of funds raised through said selling of said cavities revert to the provider.

### FIELD OF THE INVENTION

The present invention pertains to a method for raising funds for institutions while at the same time providing a means for a resting place for the remains of deceased living beings who see their lives as being intertwined with those institutions, and for whom some donation or financial commitment to that institution may be part of their overall estate planning.

### BACKGROUND

The funeral and after-death industry has long attended to the last needs of people. The traditional solution to the question of how to, in a dignified manner, dispose of the remains of the deceased has been either to bury the body in the earth or, if at sea, at the bottom of a large body of water. While these options will still be desired by many people, ecological concerns, considered in conjunction with the ever-growing world population and the increasing pressure to make available more arable land for crop production, will dictate in coming decades that other options be explored and more widely selected.

Excluding sea burial as a viable and ecological alternative, this leaves land burial. Even when sufficient tracts of land were available for the traditional burial of human remains in the ground, there has been the problem in the past of maintaining such properties in a fitting manner. Funding problems and simply the march of time have rendered often the corporations or people entrusted to oversee graveyards unable to fulfill their obligations, forcing state and local authorities to closely monitor such matters.

Many cultures have considered cremation as a preferred means of laying to rest those of the community who have passed on. Even in western culture this option has risen in popularity. However, this option has encountered problems when carried out in many areas, especially the United States.

One problem encountered has been the scattering of ashes. Many people have desired to spread the cremains of a loved one in a favorite park, lake or other area. However, many state, local and religious laws forbid such actions. Further, these acts cause a pollution which, likely is unintended by the deceased.

Even if the loved one does not scatter the remains, an awkward situation develops. The cremains are contained in an urn, which is then kept around one's home. Social situations of an unpleasant variety can occur when visitors see an urn in a home. Alternately, keepers of the remains may decide to move the remains to a less visible place, causing urns to be kept in closets, basements or other more secluded locations, or even lost. None of these scenarios gives a dignified and reverent resting place for the deceased.

Another problem has been how the cemetery industry has addressed cremation remains. Many parks and cemeteries simply allot a smaller parcel of ground for the internment. Thus, while this allows the person to be interned in less area, the cost reduction is not paralleled by the commensurate reduced area of ground utilized. Alternately, the cemeteries have mausoleums in which cremains are placed, often with memorabilia and pictures of the deceased. While a fit and dignified option, these structures are hidden, such as underneath drives and are relegated to less desirable areas. Marble and other cold building materials are used, which do not invite one to make frequent visits to the site and, if visited, do not uplift one who does visit. Such traditional designs of mausoleums may not offer the appropriately high level of reverence for the deceased loved one, particularly noting the higher elevation of expectations of the people today.

There was a time when death within a community meant a coming together of family and friends. Churches and temples buried their own in their graveyards where the history of a community, its families, whether great heroes or simple citizens, served as a powerful reminder of all that had come before. Churches and temples used to be providers for many burial services and also allowed burial of its followers in their graveyards. Today, for most, death means a rapid dash by a distraught family member to a funeral director, far removed from our daily lives, who uses seasoned sales tactics to prompt an embarrassing and hasty decision. This need not be the case.

Thus, what is needed is a burial option that provides an understanding that one's final resting place is amongst a community that sees them as part of its history, allows for an opportunity to relieve one's remaining relations of the burden in planning burial, and at the same time provides a fund raising vehicle for religious, educational, and social institutions and allows them to become involved in the internment of people who see their lives intertwined with those institutions. Additionally, what is needed is a burial structure that does not require extra real estate, enhances the memory of the departed and draws one to visit them, while doing so in a special manner. It is to these needs that the present invention is directed.

### BRIEF SUMMARY

Taking the foregoing conventional problems into consideration, an aspect of the present invention is to provide a burial option that provides people with an understanding that one's final resting place is amongst a community that sees them as part of its history while at the same time allows religious, educational, social, and community institutions a fund raising vehicle and allows them to become involved in the internment of people who see their lives intertwined with those institutions.

In one aspect, a method of raising funds and storing and displaying in a secure fashion a variable plurality of cremation storage vessels is described. The method includes a provider providing a storage and display case to an entity, wherein said storage and display case has means for retaining in a secure fashion a variable plurality of cremation storage vessels. The storage and display case has a plurality of hollow cavities, each having an opening on a front face thereof. There are means within the cavities for defining interior storage and display positions for said cremation storage vessels and other personal memorabilia. There are securing means disposed adjacent to the display positions for locking vessels disposed in those display positions. A plurality of decorative face block; are connected against and substantially aligned with, the front face of the cavities. The method further continues with reserving and selling the cavities by the entity to donors and having an agreement between said provider and said entity that a specified portion of funds raised through said selling of said cavities revert to the provider.

In a second aspect, a method of raising funds and storing and displaying in a secure fashion a variable plurality of cremation storage vessels is described. The method includes providing a burial columbarium to an entity by a provider, wherein the burial columbarium has means for retaining in a secure fashion a variable plurality of cremation storage vessels. The burial columbarium comprises a plurality of rectangular hollow cavities, each having an opening on a front face thereof. There are means within said cavities for defining interior storage and display positions for said cremation storage vessels and other personal memorabilia. There are securing means disposed adjacent to the display positions for securing vessels disposed in those display positions. The burial columbarium has a plurality of decorative face blocks; and means for connecting said decorative faces block against and substantially aligned with, the front face of the cavities. The method continues with the steps of reserving and selling the cavities to donors by said entity and having an agreement that a specified portion of funds raised through said selling of the cavities revert to the provider.

In a third aspect, the invention is a method for raising funds comprising providing a storage and display case, wherein the storage and display case includes a plurality of spaces for housing a single or a plurality of cremation storage vessels in each space; and selling the spaces to donors.

In a fourth aspect, a wall-mountable burial columbarium structure is includes a plurality of niches having adjacent top, bottom, side and back walls and an opening formed in a front surface of the niches. The opening providing access into a hollow cavity substantially horizontally disposed within said niches. A plurality of decorative face blocks covering the openings with means for connecting the face block against and substantially aligned with said front surface. There are means for securely storing cremation vessels inside said niches, wherein said cremation vessels house ashes of deceased living beings inside said niches; and means for mounting the burial columbarium structure on a wall of a building.

In an alternative embodiment, the burial columbarium has an ornamental structure around a portion of said plurality of niches.

Other objects, features and advantages of the present invention will become apparent from the following detailed description. It should be understood, however, that the detailed description and the specific examples, while indicating embodiments of the invention, are given by way of illustration only, the invention being defined only by the claims following this detailed description.

### BRIEF DESCRIPTION OF SEVERAL VIEWS OF THE DRAWINGS

FIG. 1 is a schematic of a fund raising method of the present invention;

FIG. 2 is a flowchart illustrating the steps for a fund raising method of the present invention;

FIG. 3 is a flowchart illustrating the steps for another embodiment of a fund raising method of the present invention;

FIG. 4 is a flowchart illustrating an example for a fund raising method of the present invention;

FIG. 5 is a perspective front view of the burial columbarium of the present invention;

FIG. 6 is a cross-sectional view of the burial columbarium of the present invention;

FIG. 7 is a partial front view of the burial columbarium displaying niches of the present invention;

FIG. 8 is a front view of the burial columbarium displaying means for wall-mounting that are superimposed on said front view;

FIG. 9 is a perspective view of the wall mounting system used in an embodiment of the present invention; and

FIG. 10 is a partial cross-sectional view of the wall mounting system used in an embodiment of the present invention.

### DETAILED DESCRIPTION OF THE PRESENTLY PREFFERED EMBODIMENTS

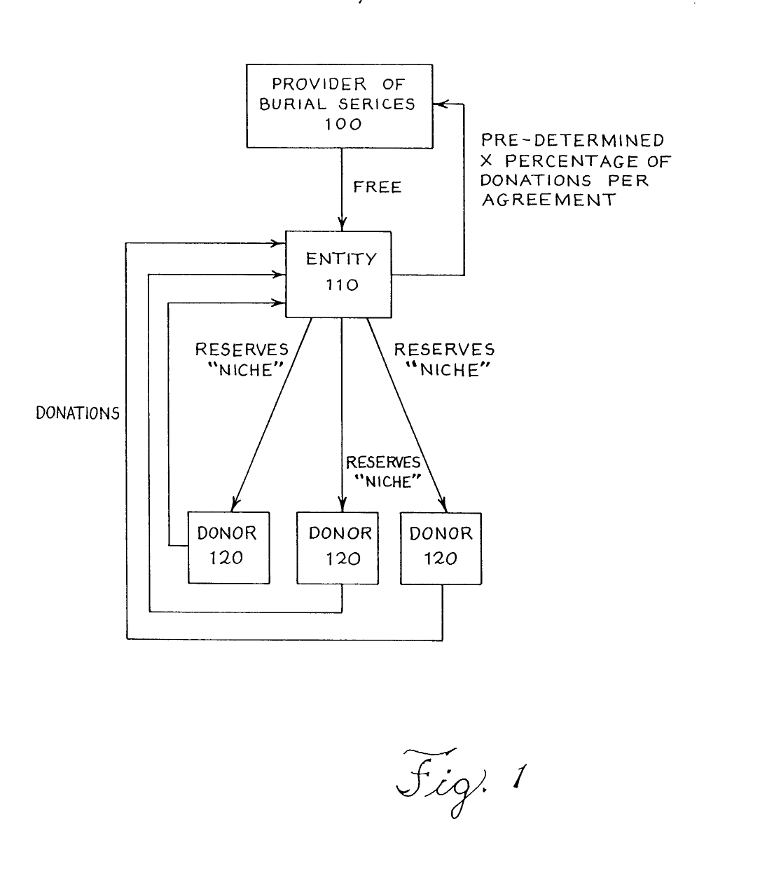

Referring now to the embodiments of FIGS. 1-5 of the present invention, there is found a method for raising funds using wall-mountable burial structures. The method allows for an alternate choice for internment that provides an opportunity to relieve ones remaining relations of the burden in planning for burial, it allows a person the ability to donate to a favored institution, preferably, in a tax deductible manner benefiting ones estate and the institution, and provides one with the understanding that ones final resting place is amongst a community that sees them as part of its history.

As illustrated in FIG. 1, in one embodiment, the method begins with a provider 100 that provides a burial structure to an entity 110. The provider 100 may also design and manufacture the burial structures. The entity 110, is preferably an institution such as a religious institution, educational institution, fraternal organization, social or other community organization. The provider 100 may supply the burial structures free of charge, but it is not essential to the practice of this method. The burial structure is a storage and display case. The burial structure preferably is a wall-mountable burial columbarium that holds therein a plurality of cremation vessels housing the remains of deceased living beings. The burial columbarium comprises of a plurality of niches or cavities, capable of securing and holding one or more cremation vessels. It is preferable that the burial columbariums be aesthetically designed to house and store the cremation vessels in a fit and dignified fashion. The niches or cavities have a face block that identifies the donor along with selected biographical information. These burial columbariums are preferably displayed prominently on the entity's property. For example, the columbarium may be mounted on a wall inside of a chapel. The columbarium may also be stored in a place of historic or spiritual value.

The entity 110 then uses the burial columbariums as fund raising vehicles. Entity 110 offers donors 120 an opportunity to reserve a niche or cavity in the burial columbariums. By donating something of monetary value to the entity 110, the donors 120 will then be entitled to have their remains interned in a place that is intertwined with their lives.

The method continues with the donors 120 paying either a one-time fee or installment payments, or any other conventional forms of payments to reserve and purchase a niche on the burial columbarium. If the institution is non-profit, the donor 120, in addition to obtaining a dignified alternative option to burial, may also obtain the additional advantage of a tax-deductible donation to a favored institution. The further result, is the creation of a truly significant new fundraising vehicle for these entities 110.

The method further continues with the entity 110, by agreement, paying provider 100 a pre-determined percentage of the funds received from reserving the niches to donors 120. Generally, fundraising efforts outsourced to professional consultants net anywhere between 10 percent and 25 percent on average for the provision of the service. It is envisioned that a similar fee amount would be charged for providing the fundraising method of the present invention.

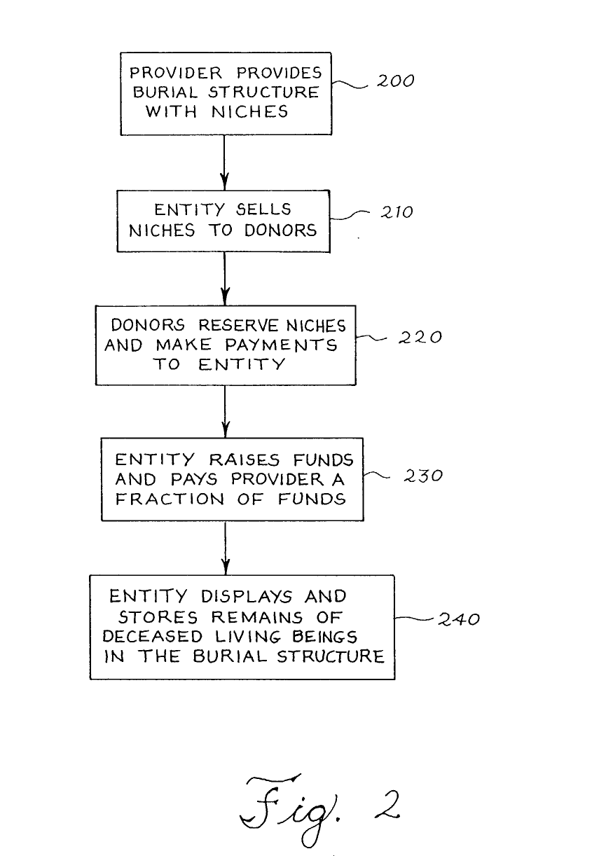

Illustrated in FIG. 2 is a flowchart of an embodiment of the fundraising method of the present invention. Although the method is broken down into steps, it is not necessary that the steps be carried out in the order displayed. It is possible, to carry out the method by following the steps in any order. The method begins with step 200 where a provider 100 provides a burial structure to an entity 110. The burial structure may be a burial columbarium, a veteran's memorial plaque, memento casque, or other burial structures capable of housing remains of a plurality of deceased living beings. In step 210 and 220, the entity 110 sells spaces or niches in the burial structure to potential donors 120 who see their lives intertwined with said entity 110 and who wish to have their remains interned at said entity 110. The burial structure is preferably prominently displayed on the property of said entity 110 and would display the name and other biographical information of said donor 120. In this manner, the donor 120 would have an alternative means for burial that would provide him or her an opportunity to find a resting place with others who are historically intertwined with said entity 110. Donors 120 could also reserve and purchase a niche on someone else's behalf, such as a family member or loved one, provided that proper authorization is obtained from the other person.

In step 230, the method continues with the entity 110 raising much needed funds through reserving and selling niches on the burial structure. The entity then, by agreement, pays said provider 100 a pre-determined percentage of said funds. It is envisioned that the pre-determined percentage would be similar to arrangements made with other providers of fund raising vehicles for said entities.

In step 240, the entity 110 displays and stores remains of deceased living beings in the burial structure provided by provider 100. The entity 110, preferably, displays the burial structure on the entity's property preferably prominently displayed and memorializing the donors 120 whose remains are interned in cremation vessels inside said burial structure.

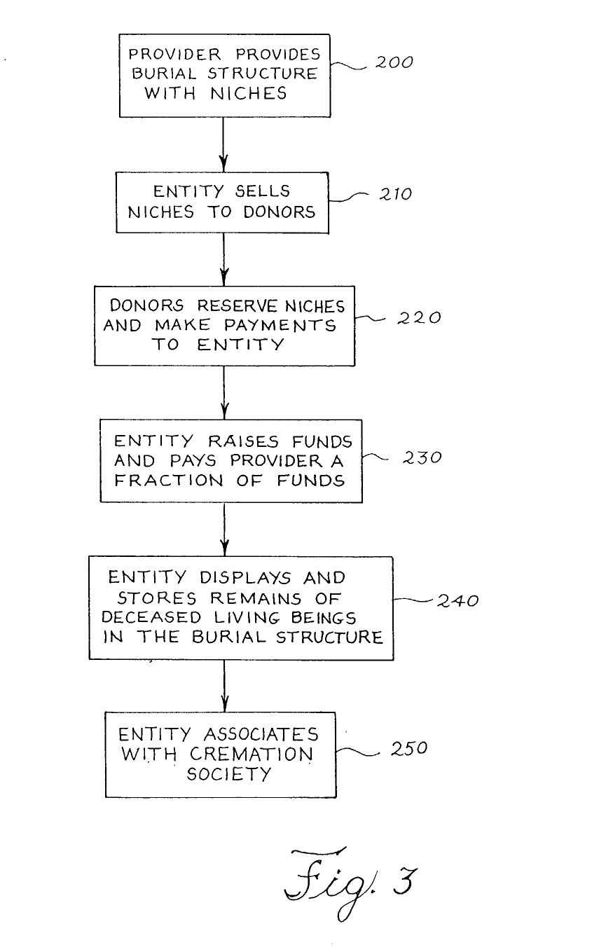

FIG. 3 illustrates another embodiment of the fund raising method. As illustrated, the method is substantially similar to the method outlined in FIG. 2, the change being in the added feature or step 250 of providing an association between the entity 110 and a cremation society 140. Cremation societies 140 exist in the United States and provide low cost burial services through a non-profit system as a community service. An agreement between the institution and a cremation society 140 would enable the institution to possibly assist the donor's 120 remaining kin with the usual obligations associated with death and thereby provide superior care or direction within the “community” of the institution. The provider 100 may offer an additional service to associate or link the entities 110 to a variety of cremation societies 140.

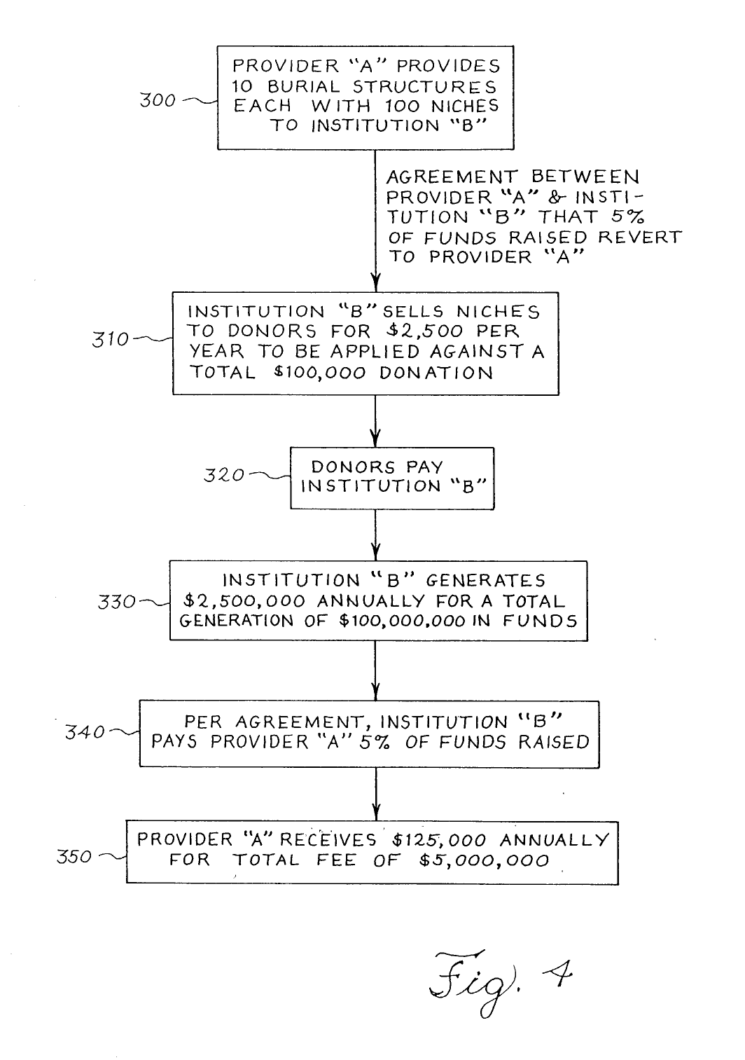

FIG. 4 illustrates one example of the present method. In step 300, Provider A designs, manufactures and provides burial structures and other similar and related systems to an Institution B with the agreement that a specified portion of the funds raised through the reservation and sale of the actual internment niches within the burial structure revert to Provider A. Reservation of a niche within the burial structure marks a bond with the institution which is recognized and recorded with the application of the donor's name upon the burial structure. In step 310, for example, a major institution B may lease a niche within a burial structure for $2,500 per year to be applied against an eventual total $100,000 donation. In step 320, the donors pay institution B. Institution B will then house the cremated remains of the donor in a niche in said burial structure. The donor's name and biographical data will also appear on the burial structure to recognize the donor and his or her contributions. Steps 330, 340, and 350 illustrate that if institution B obtained 10 burial structures each with a 100 niches, institution B could generate $2,500,000 annually in funds. If the institution is not-for-profit as defined in the United States Tax Code, the donor would receive the additional benefit of a tax-deductible donation.

In the present example, if Provider A's fee for the burial structures is 5 percent of the funds raised, Provider A would receive $125,000 annually of the total $2,500,000. Institution B would receive a net of $2,375,000 annually in funds. The ultimate gross contribution to institution B would be a $ 100,000,000, or a net of $95,000,000 after deducting $5,000,000 of Provider A's 5 percent fee. The above described method envisions a potential for unrestricted funds, and the donations most sought by the majority of institutions is sizeable. In the above example, Provider A would provide similar services as compared to other services provided by professional consultants for fundraising efforts. In the present example, institution B potentially bears no expense for the design, fabrication, and perhaps even installation of the burial structure, yet enjoys what may be a substantial flow of revenue for reserved niches, and can also, if desired, set payment at the settlement of the decedent's estate. The design, manufacture, installation of the burial structure can all be done by provider A.

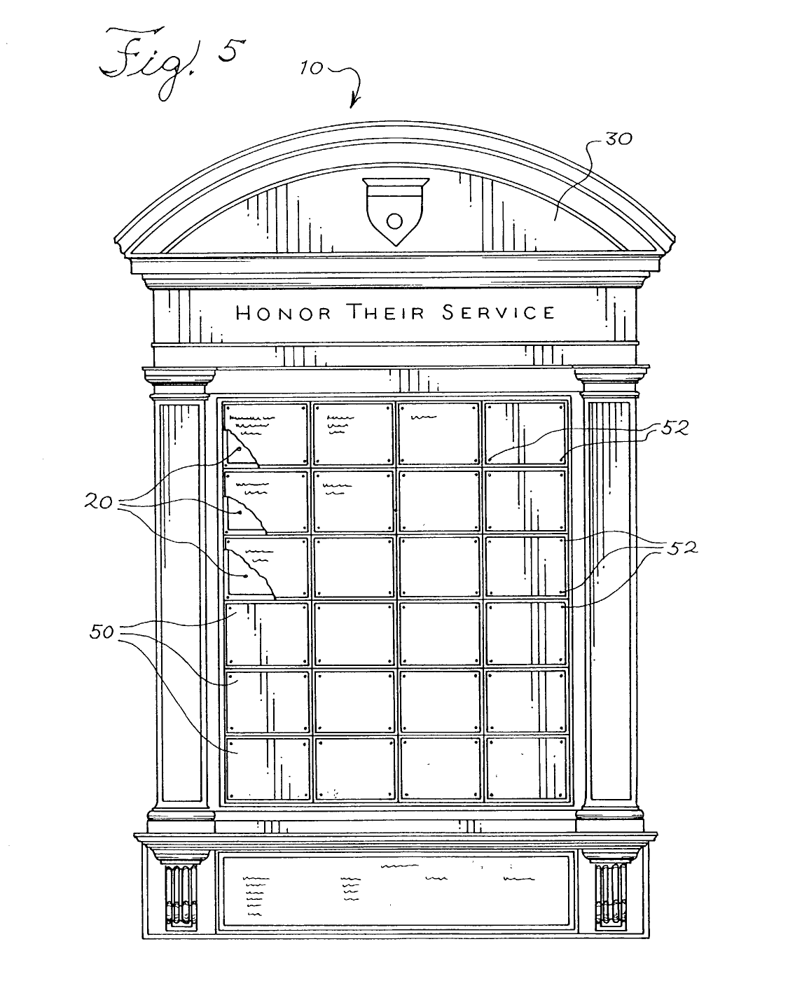

A preferred burial structure that can be used for the above fund raising method, is a burial columbarium 10 as illustrated in FIGS. 5 and 6. The burial columbarium 10 has means for holding therein the remains of multiple deceased living beings. The burial columbarium 10 comprises a plurality of individual burial units that are niches 20 or spaces in the burial columbarium structure.

The burial columbarium 10 is formed in a generally rectangular design with classical ornamental features 30. An example of classical ornamental features would be Grecian or Roman ornamental features. A crest or other distinguishing mark of the entity 110 may also be placed on a surface of said ornamental features 30. Other letters or words may also be placed on a surface of said ornamental features 30. The shape of the columbarium is alterable to many desired forms; what is critical is that the disposition of the remains is within the burial columbarium and in a container that allows for the housing of the remains, preferably in an urn or other cremation vessel.

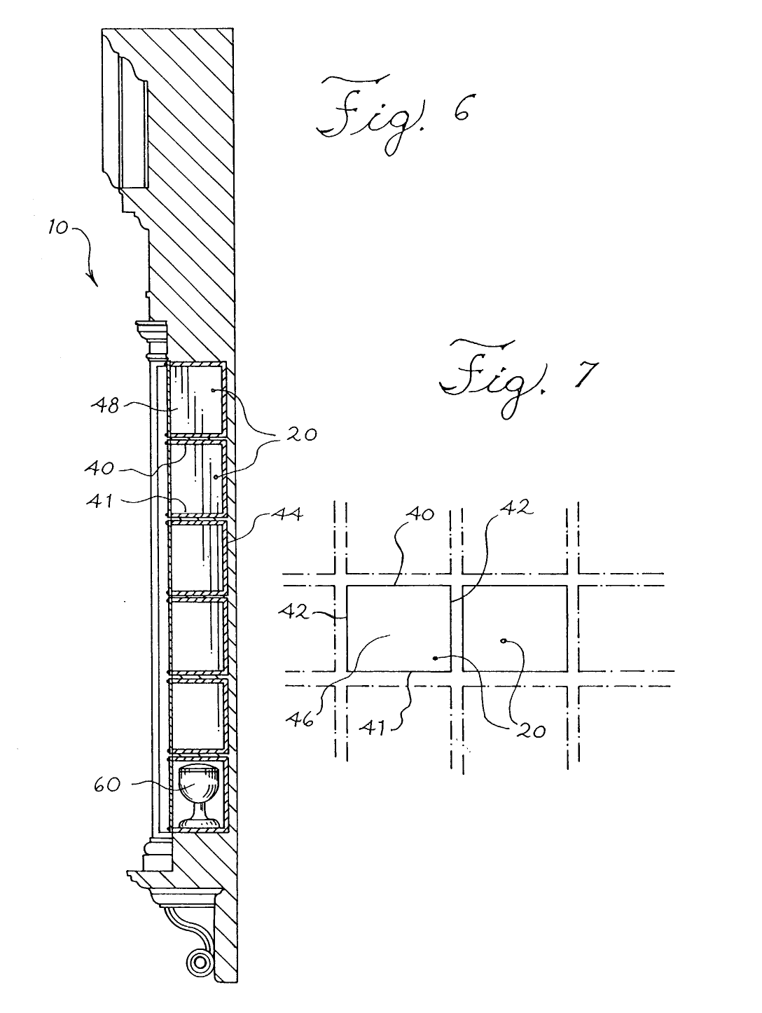

The burial columbarium has a plurality of niches 20 having adjacent top 40, bottom 41, side 42 and back 44 walls, as illustrated in FIG. 7. An opening 46 is formed in a front surface of the niches 20 which provides access to a hollow cavity 48 inside the niche and substantially horizontally disposed within the niche. The columbarium also has a plurality of decorative face blocks 50 that cover the openings 46 on the niches 20, as illustrated in FIG. 5. The face blocks 50 serve to identify and memorialize the deceased person whose cremated ashes are hermetically interred within the niche. The face blocks 50 preferably have the name of the donor engraved on them and may contain other biographical information, such as the birth date, date of death, and other contributions of the donor to the community and society. The face block 50 is aligned against and connected to the front surface of the opening 46 by fasteners 52. Other traditional means of connecting may also be employed for connecting the face block 50 to the front surface of the opening. The face block 50 may also have a bracket on the front surface thereof for holding an alabaster votive candle 52 that is merely hooked on the face block 50 at the ceremony for internment of the ashes or on memorial/anniversary occasions. The face block 50 can be made of a variety of materials including stones, such as marble, or wood. The face block 50 may also be made of a transparent material such as glass or plastic that would allow for the display of the actual cremation vessels 60.

As illustrated in FIG. 6, the niches have a cavity 48 for storing cremation vessels that house the ashes of deceased living beings. The cremation vessel 60 is placed inside of the niche and is securely fastened to a wall of the niche. The cremation vessels may also be securely fastened by placing them in a cavity that is in the shape of a back side of the cremation vessel.

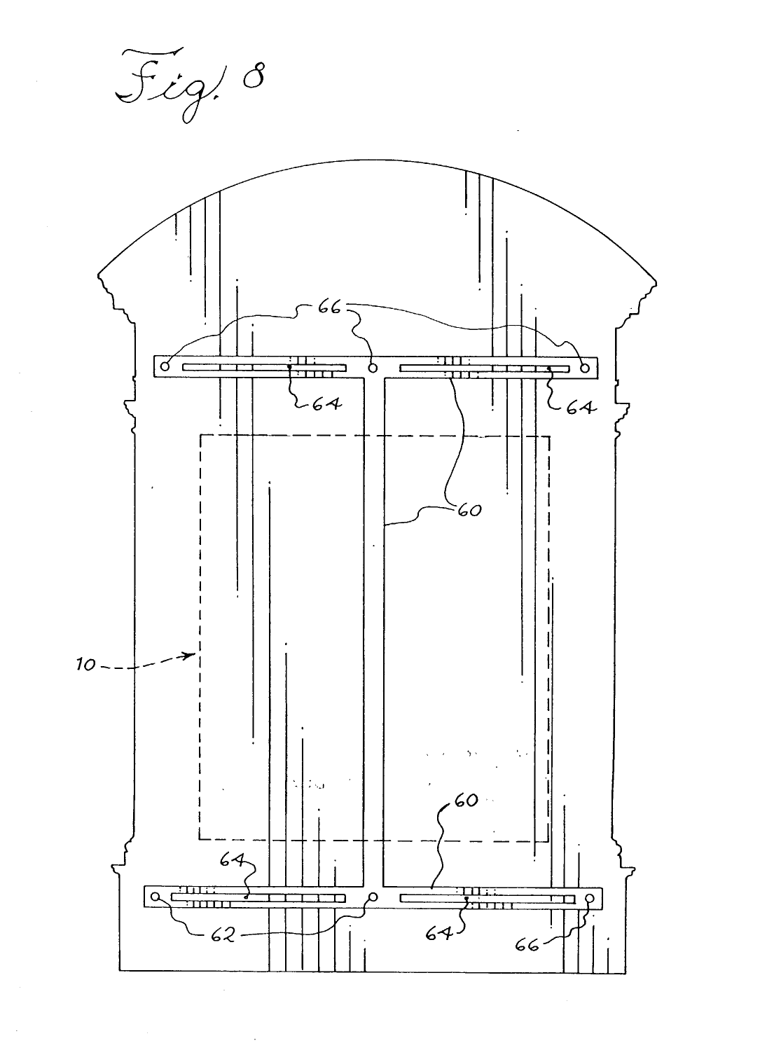

The burial columbarium 10 is wall-mountable through the use of a variety of conventional mounting devices. Preferably, the burial columbarium is mounted on a wall in such a way that the mounting means are hidden from a front view of the columbarium. As illustrated in FIG. 8, one means for mounting a burial columbarium to a wall is by using tie bars 60 with bolts 66. The tie bars 60 are placed on a rear surface of the burial columbarium 10. The number of tie bars 60 needed and the positioning of the tie bars 60 varies depending on the size and shape of the burial columbarium structure 10.

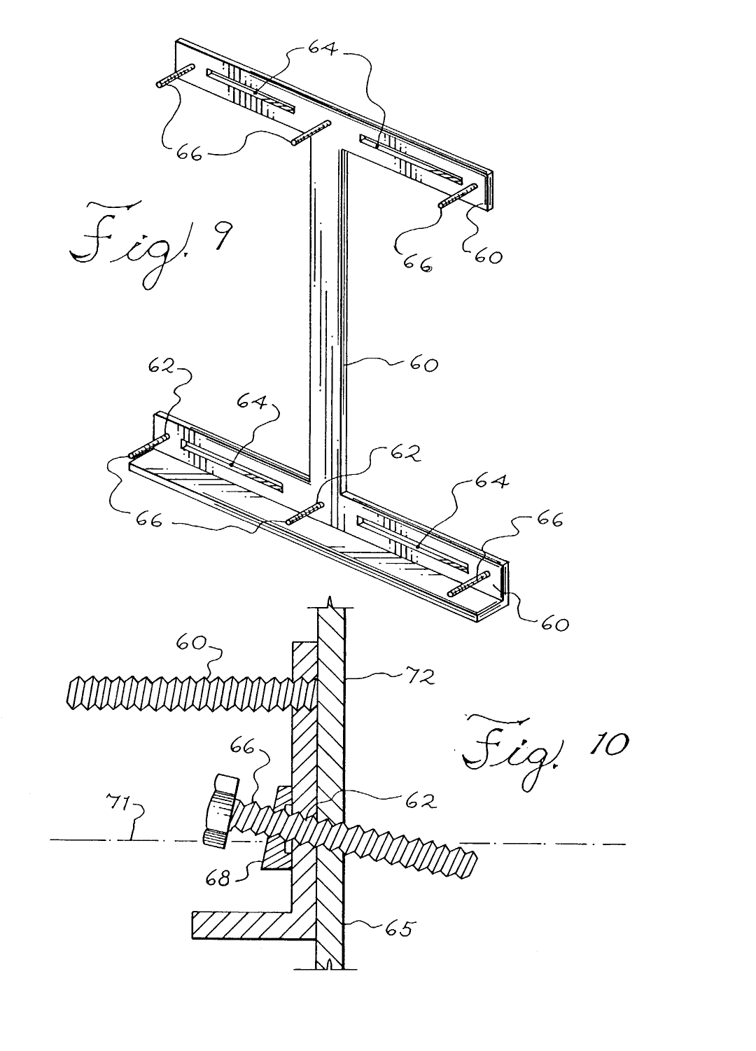

As illustrated in FIG. 9, there are holes 62 in tie bars 60 for retaining a bolt 66. Staggered slots 64 provide an opening through which an anchor plate might be secured to provide relieving support within wood framed walls where large sized units might require securing to a wall plate for structural purposes. In solid masonry walls of brick or stone, the relieving support and anchor plate system within the wall itself would be unnecessary.

Illustrated in FIG. 10 is a partial cross-sectional view of the mounting means. An angled swage plate 68 is placed around a threaded bolt 66. The bolt is then inserted into the hole 62 in tie bar 60. The angled swage plate 68 allows the bolt to fastened to a wall 72 at an acute angle with respect to a perpendicular horizontal plane 71 of the wall 72. Fastening the bolt at an angle provides greater support. The back plate 65 of the tie bar 60 is preferably a steel back plate. The ability to mount the columbarium 10 on a wall saves much needed floor space and provides further convenience as a burial structure and as a fund raising vehicle.

From the foregoing description and by reference to the figures of the drawings it will be perceived that the fundraising method through the use of burial structures, such as the columbarium described above, present a unique approach to, and concept of, raising funds and internment of the earthly remains of deceased living beings. The fund raising method connects the needs of people to find an alternate means of burial to institutions capable of providing those means. The institutions simultaneously benefit through the creation of a substantial new fundraising vehicle providing a valuable service to its members. Furthermore, the alternate means for internment provides other intangible benefits such as the peace and understanding provided by being in a final resting place that is amongst a community that sees one as a part of its history. The burial means provide a proper, aesthetic, dignified, and reverent memorial to the deceased that is much easier and more pleasant to visit than a cemetery or a mausoleum. Finally, the greatest advantage contemplated by the present invention is to bring greater involvement of religious, social, and community organizations to burial and death within the community.

While the invention has been particularly shown and described with reference to a preferred embodiment thereof, it will be understood by those skilled in the art that changes in form and detail may be made therein without departing from the spirit and scope of the invention. Thus, although the preferred embodiment for a burial structure shown in FIGS. 5-8 is a rectangular vessel with four sides, the present invention can be applied to make vessels of other forms. For example, the burial structure could be practiced to form a niche having a triangular cross-section with its walls adjacent to walls of other triangular niches to allow the formation of a plurality of niches as a display and storage wall with a concept similar to that shown in FIG. 5. Similarly, the present invention could be practiced to make burial structures having niches with pentagonal cross-sections, hexagonal cross-sections, octagonal cross-sections, etc. Also, the burial structure may be supported on a platform, embedded in a floor, or located in any of a number of visible locations.

1. A method for raising funds comprising:
(a) providing a storage and display case, wherein said storage and display case comprises a plurality of spaces for housing a single or a plurality of cremation storage vessels in each space; and
(b) selling said spaces to donors by an entity for raising funds through the sale of said spaces, wherein said donors are associated with said entity.

2. The method of claim 1, wherein a provider provides said storage and display case to said entity.

3. The method of claim 2, wherein said provider provides the storage and display case to said entity for free in return for a portion of revenue from sales of said spaces.

4. The method of claim 2, further comprising said provider having an agreement with said entity that a specified portion of funds raised through said selling of said spaces revert to said provider.

5. The method of claim 2, wherein said selling of said spaces further comprises:
(a) said donor reserving said space for storage of cremation storage vessels for X amount of money paid to said entity;
(b) said donor paying said entity Y amount of money per period of time until the total amount of money paid by donor to said entity equals X amount of money; and
(c) said entity paying said provider a pre-determined percentage of said money paid to said entity by said donor.

6. The method of claim 1, wherein said storage and display case comprises one of a wall-mounted burial columbarium, an outdoor burial columbarium, a veteran's memorial plaque, and a memento casket.

7. The method of claim 1, wherein said entity comprises one of a religious institution, an academic institution, a military institution, a veteran's organization, a private club, a fraternal organization and a community organization.

8. The method of claim 1, wherein said entity is a non-profit institution.

9. The method of claim 2, wherein said storage and display case is located on said entity's property.

10. The method of claim 1, wherein said cremation storage vessels contain ashes of deceased living beings.

11. The method of claim 2, wherein said ashes of deceased living beings are of deceased living beings associated with said entity.

12. The method of claim 10, further comprising associating said entities with a cremation society to enable said entities to assist family members of said deceased living beings with ritual obligations associated with death.

13. A method of raising funds and storing and displaying in a secure fashion a variable plurality of cremation storage vessels comprising:
(a) a provider providing a storage and display case to an entity, wherein said storage and display case has locations for retaining in a secure fashion a plurality of cremation storage vessels, the storage and display case comprising:
i) a plurality of hollow cavities, each hollow cavity having an opening on a front face thereof;
ii) boundary members within said cavities for defining interior storage and display positions for said cremation storage vessels and other personal memorabilia;
iii) storage vessel retainers disposed adjacent to the display positions for securing vessels disposed in those display positions;
iv) a decorative face block, configured to be connected with and substantially aligned against said front face of said cavites;
(b) reserving and selling said cavities by said entity to donors; and
(c) said provider receiving a specified portion of funds raised by said entity through said selling of said cavities.

14. A method of raising funds and storing and displaying in a secure fashion a variable plurality of cremation storage vessels comprising the steps of:
(a) providing a burial columbarium to an entity by a provider, wherein said burial columbarium has means for retaining in a secure fashion a variable plurality of cremation storage vessels, said burial columbarium comprising:
i) a plurality of rectangular hollow cavities, each having an opening on a front face thereof;
ii) a plurality of decorative face blocks, wherein each of said face blocks is attachable to said front surface of said cavities;
(b) reserving and selling said cavities to donors by said entity; and
(c) said provider and said entity agreeing that a specified portion of funds raised through said selling of said cavities revert to said provider.

15. A wall-mountable burial columbarium structure comprising:
(a) a plurality of niches having adjacent top, bottom, side and back walls and an opening formed in a front surface of said niches, said opening providing access into a hollow cavity substantially horizontally disposed within said niches;
(b) a plurality of decorative face blocks covering said openings;
(c) means for connecting said face block against and substantially aligned with said front surface;
(d) means for securely storing cremation vessels inside said niches, wherein said cremation vessels house ashes of deceased living beings inside said niches; and
(e) means for mounting said burial columbarium structure on a wall of a building.

16. The burial columbarium structure of claim 15, wherein the means for mounting said burial columbarium structure on a wall are preferably on a back side of the back panel of said plurality of niches.

17. The burial columbarium structure of claim 15, wherein the means for mounting said burial columbarium structure on a wall are hidden when said burial columbarium structure is mounted on a wall.

18. The burial columbarium structure of claim 15, wherein the means for mounting said burial columbarium structure on a wall is a hook and

19. The burial columbarium structure of claim 15, further comprising said cremation vessels for storing the ashes of deceased living beings.

20. A wall mounted burial columbarium structure comprising:
(a) a plurality of niches having adjacent top, bottom, side and back walls and an opening formed in a front surface of said niches, said opening providing access into a hollow cavity substantially horizontally disposed within said niches;
(b) a plurality of decorative face blocks covering said openings;
(c) means for connecting said face block against and substantially aligned with said front surface;
(d) means for securely storing cremation vessels inside said niches, wherein said cremation vessels house ashes of deceased living beings;
(e) means for mounting said burial columbarium structure on a wall of a building; and
(f) an ornamental structure around a portion of said plurality of niches.

21. The burial columbarium of claim 20, wherein a crest or other distinguishing mark of an entity is placed on a surface of said ornamental structure.

22. The burial columbarium of claim 20, wherein letters and words are placed on a surface of said ornamental structure.

23. The burial columbarium of claim 20, wherein said ornamental structure is shaped in classical designs, preferably Grecian or Roman designs.

24. A method of raising funds and storing and displaying in a secure fashion a variable plurality of cremation storage vessels comprising:
(a) an entity obtaining a storage and display case from a provider, wherein said storage and display case has locations for retaining in a secure fashion a plurality of cremation storage vessels, the storage and display case comprising:
i) a plurality of hollow cavities, each hollow cavity having an opening on a front face thereof;
ii) boundary members within said cavities for defining interior storage and display positions for said cremation storage vessels and other personal memorabilia;
iii) storage vessel retainers disposed adjacent to the display positions for securing vessels disposed in those display positions;
iv) a decorative face block, configured to be connected with and substantially aligned against said front face of said cavites;
(b) reserving and selling said cavities by said entity to donors to raise funds; and
(c) said entity paying said provider a specified portion of funds raised by said entity through selling of said cavities.
